(19) United States
(12) Patent Application Publication
(10) Pub. No.: US 2008/0111345 A1
(43) Pub. Date: May 15, 2008

(54) Bracket For Motorcycle Foot Supporting Device

(76) Inventor: Clinton E. Springer, Sanford, ME (US)

Correspondence Address: CHRIS A. CASEIRO, VERRILL DANA, LLP, ONE PORTLAND SQUARE, PORTLAND, ME, 04112-0586, US

(21) Appl. No.: 11/559,184

(22) Filed: Nov. 13, 2006

(51) Int. Cl. B62J 25/00

(52) U.S. Cl. 280/291

(57) ABSTRACT

A bracket which may be used to removably connect a genuine Harley-Davidson Inc. foot supporting device to one of its Softail® motorcycles having a modified exhaust pipe system. The bracket includes a base member removably connectable to a motorcycle and a support connecting member removably connectable, either directly or indirectly, to the foot supporting device. When removably connected to the right side of Harley Softail® motorcycle having an aftermarket-modified exhaust system, the bracket holds the foot supporting device in a position away from the exhaust system and from the rest of the motorcycle. When removably connected to the left side of a Harley Softail® motorcycle, the bracket holds the foot supporting device in a position away from the motorcycle. This arrangement allows a passenger to avoid contacting the exhaust system with his/her right foot, and to rest both feet comfortably while riding on the motorcycle.

### BACKGROUND OF THE INVENTION

1. Field of the Invention

The present invention relates to brackets. More particularly, the present invention relates to brackets which may be removably connected to a motorcycle. Still more particularly, the present invention relates to brackets for removably connecting footboards and footpegs to a motorcycle. Even more particularly, the present invention relates to brackets for removably connecting footboards manufactured by the Harley-Davidson Inc. of Milwaukee, Wis. to Softail® motorcycles manufactured by that same company.

2. Description of the Prior Art

Motorcycle enthusiasts number in the millions in the U.S. and abroad. Many motorcycle owners not only enjoy the thrills of riding, but also enjoy other pleasures associated with motorcycle ownership. As one such pleasure, some motorcycle owners enjoy reconstructing a newly purchased motorcycle to fit their riding needs and design tastes. For example, they may remove or rearrange all or part of their motorcycle's exhaust system.

Another pleasure is the camaraderie and sense of exclusivity that exists among motorcycle owners. To foster this camaraderie, many owners participate in riding groups and attend motorcycle-associated events, at which they proudly show and discuss their motorcycles. Because many owners are loyal to a particular motorcycle manufacturer, it is not surprising that the motorcycles ridden in a particular riding group and at a particular motorcycle-based event often are made by a common manufacturer. Perhaps no motorcycle manufacturer in the world has a greater following of loyal customers than does the Harley-Davidson Inc. (“Harley”) of Milwaukee, Wis.

Part of Harley's appeal is that it manufactures motorcycles of many designs. Collectively, these designs are fragmented into several different design groups. One particular design group is Harley's Softail® line. Softail® motorcycles are factory equipped with, among other things, a chrome staggered exhaust having two mufflers on the right side of the motorcycle. One of the mufflers is connected to an upper exhaust pipe and the other to a lower exhaust pipe. Harley includes with these motorcycles a footpeg adjacent to the muffler of the upper pipe for resting the right foot of a motorcycle passenger (i.e., one who rides on the “back” of a motorcycle behind the motorcycle's operator). Since the footpeg is not sufficiently removed from the upper pipe, the passenger's foot is likely to contact the hot pipe while riding. However, because the footpeg is not substantially extended from the side of the motorcycle, the passenger is forced to keep his/her right foot close to the motorcycle and in a position which is substantially parallel to the upper pipe. Since the passenger's right foot is so restricted to this position, the passenger's right leg usually becomes sore soon after beginning a ride. Further, Harley Softail® motorcycles include a second footpeg for resting a passenger's left foot. Since this left footpeg, like the right footpeg, is not substantially extended from the motorcycle, the passenger is likely to experience similar discomfort in his/her left leg due to restriction in movement.

Many Softail® owners remove the factory-installed mufflers and reconfigure the exhaust system after taking delivery of their motorcycle. Unfortunately, this aftermarket modification creates a problem not characteristic of unmodified Softail® motorcycles, which is namely that it leaves the right foot of any passenger susceptible to burning. Specifically, this is true because reconfiguration typically involves moving the upper pipe from its factory-installed position adjacent to the right footboard to a position directly below the footboard. This general reconfiguration is shown in FIG. 1. In the figure, in some aftermarket modifications of a Softail® motorcycle, an upper exhaust pipe 10 and a lower exhaust pipe 20 are repositioned from Harley's original design such that a Harley-installed foot supporting device 30 on the right side of the motorcycle is held directly above the upper exhaust pipe 10. This arrangement leaves the right foot of a passenger riding on the motorcycle, which rests on the foot supporting device 30 just above the upper pipe 10. Therefore, to avoid contacting the hot pipe 10 when it is arranged in this position, the passenger must keep his/her foot substantially parallel to the pipe 10 while riding. Strictly maintaining this position, however, is both uncomfortable and difficult to do. Therefore, whether it be to foot fatigue, an unexpected shift of body weight, such as which may be caused by a kbump in the road, or inattention, the passenger oftentimes will contact the pipe 10 with his/her foot. This contact may cause the passenger's shoe to be melted or, worse, the passenger's foot to be burned. Further, regardless of whether a particular Softail® motorcycle has been modified as described, because the Harley-installed foot supporting device 30 present on the right side of the chassis 5 and the Harley-installed foot supporting device 30 present on the left side of the chassis 5 (not shown) are held relatively close to the chassis 5, and the passenger therefore must hold his/her legs substantially immobile, the passenger's legs are susceptible to cramping during a ride.

Softail® owners have taken two steps to address this problem. One, they have obtained footboards commercially available from various manufacturers, but not from Harley, and have attached these “aftermarket” footboards to their motorcycle by using aftermarket brackets that, like the footboards, are not manufactured by Harley. Many Softail® owners, especially those who are loyal to Harley, do not find this option to be adequate because it requires having to fit their Harley-made motorcycle with an aftermarket, or “non-Harley,” footboard. Further, this option is undesirable because it requires the owner, who already owns the Harley footboards or footpegs that were provided with his/her motorcycle, to incur the added expense of having to purchase another set of footboards. Even further, none of these aftermarket products allow a passenger's leg to be substantially extended from the motorcycle, which means that, for reasons already described, such a passenger would be susceptible to painful leg cramping.

In a second option, some Softail® owners have elected to get around this problem by using a crude approach. For example, some have elected to weld a section of the pipe directly to the frame of the motorcycle. While this may be somewhat effective, it detracts from the overall appearance of the motorcycle. As another example, some have fabricated crude fastening devices and have used these crude devices to fasten the Harley-supplied footboard to their motorcycle. Unfortunately, however, since the load strengths of these crude fastening devices are unknown, they may be prone to failure. When these devices fail, a rider of the motorcycle may suffer serious bodily injury.

Indeed, there is no device which allows a Softail® motorcycle, having an exhaust system as modified as described above, to be equipped with genuine Harley footpegs or footboards in a fashion which enables a passenger riding on the motorcycle to rest his/her right foot both comfortably and away from the motorcycle's upper exhaust pipe. What is needed therefore is a bracket connectable to a motorcycle and a footboard which will allow a Softail® motorcycle having an exhaust system modified as described above to be equipped with genuine Harley footboards. The needed bracket further should enable a passenger riding on the motorcycle to rest his/her right foot both comfortably and away from direct contact with the motorcycle's upper exhaust pipe. The needed bracket also should not detract from the appearance of the motorcycle but should instead present an appearance consistent with the rest of the motorcycle.

### SUMMARY OF THE INVENTION

It is an object of the present invention to provide a bracket which may be used to removably connect a genuine Harley-manufactured footboard to a Harley Softail® motorcycle having an aftermarket-modified exhaust system. It is another object of the present invention to provide a bracket for removably connecting a footboard to such a motorcycle which further allows a foot of any passenger on the motorcycle to be positioned away from the motorcycle for the purpose of minimizing or avoiding leg discomfort. It is yet another object of the present invention to provide a bracket for removably connecting a footboard to such a motorcycle which allows a foot of any passenger on the motorcycle to be positioned away from the motorcycle for the purpose of minimizing or eliminating the possibility that the foot will contact the upper exhaust pipe of the motorcycle. It is another object of the present invention to provide a bracket for removably connecting a footboard to such a motorcycle which is compatible with the overall appearance of the motorcycle.

These and other objects are achieved by the bracket of the present invention. The bracket has two forms: a left-handed form and a right-handed form. The left-handed form is removably connectable to the left side of a motorcycle, and the right-handed form is removably connectable to the right side of a motorcycle. In both forms, the bracket includes a base member having a motorcycle mounting face, which faces toward the motorcycle when the bracket is connected to the motorcycle, and a support connecting face, which faces away from the motorcycle when the bracket is removably connected to the motorcycle. The support connecting face includes a connecting member for removably connecting a foot supporting device, which may be a footboard or footpeg, for example, to the motorcycle. Specifically, the foot supporting device may be removably connected to the connecting member via a support arm. When the foot supporting device is removably connected to a motorcycle by the bracket of the present invention, the foot supporting device is pivotable toward or away from the motorcycle. For example, the foot supporting device may be pivoted toward the motorcycle to reduce the possibility that a passerby will contact the foot supporting device when the motorcycle is parked.

The details of one or more examples related to the invention are set forth in the accompanying drawings and the description below. Other features, objects, and advantages of the invention will be apparent from the following description and accompanying drawings, and the appended claims.

### BRIEF DESCRIPTION OF THE DRAWINGS

FIG. 1 is a top view of a foot supporting device connected by the prior means for positioning directly above an upper exhaust pipe of an aftermarket-modified Softail® motorcycle.

FIG. 2 is a top view of the foot supporting device positioned above and substantially away from the upper exhaust pipe of the aftermarket-modified Softail® motorcycle of FIG. 1.

FIG. 3A is a front view of a left-handed bracket of the present invention.

FIG. 3B is a front view of a right-handed bracket of the present invention.

FIG. 4A is a side view of a preferred embodiment of the left-handed bracket of the present invention.

FIG. 4B is a side view of a preferred embodiment of the right-handed bracket of the present invention.

FIG. 5A is a side perspective view of the left-handed bracket of the present invention removably connected to a motorcycle and a foot supporting device.

FIG. 5B is a side perspective view of the right-handed bracket of the present invention removably connected to the motorcycle and a foot supporting device.

FIG. 6A is an exploded perspective view of a first connecting device and the left-handed bracket of the present invention.

FIG. 6B is a perspective view of the left-handed bracket of the present invention removably connected to the motorcycle by the first connecting device and a second connecting device.

FIG. 6C is an exploded perspective view of the left-handed bracket of the present invention removably connected to the motorcycle, and a support arm and a foot supporting device.

### DETAILED DESCRIPTION OF THE PREFERRED EMBODIMENT

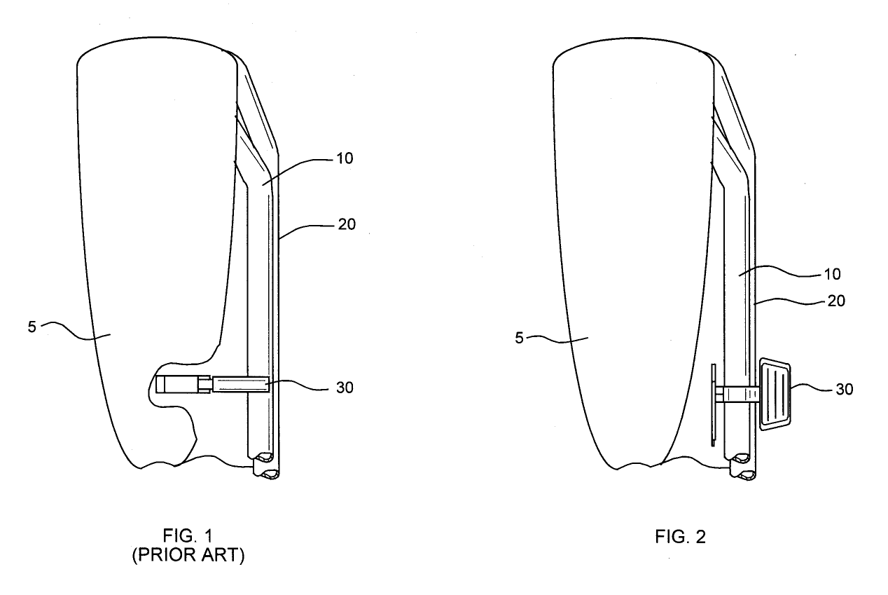

The present invention is a bracket for removably connecting a footboard manufactured by Harley-Davidson Inc. (“Harley”) of Milwaukee, Wis., to a Harley Softail® motorcycle having a modified exhaust pipe system. Generally, as shown in FIG. 2, when removably connected to the right side of a Softtail® chassis 5, the bracket of the present invention allows the original foot supporting device 30 supplied by Harley with the Softtail® motorcycle to be positioned above and substantially away from the exhaust pipes 10/20. Similarly, when removably connected to the left side of the chassis 5 (not shown), the bracket allows the Harley foot supporting device 30 to be positioned substantially away from the chassis 5.

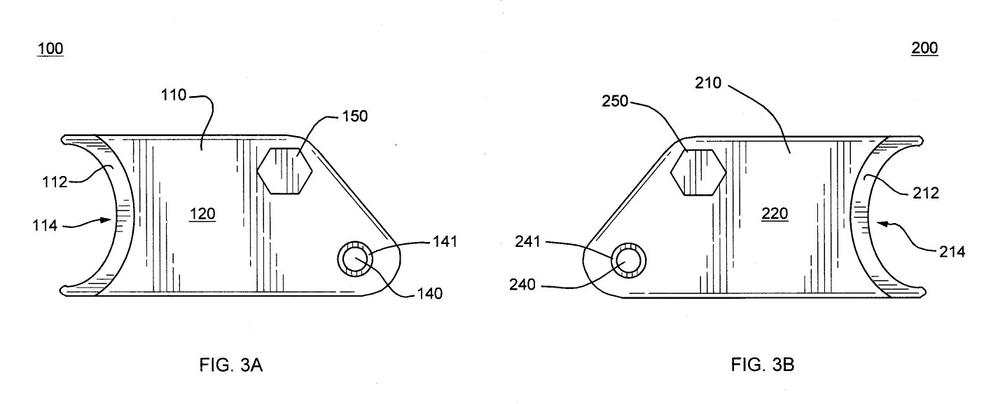

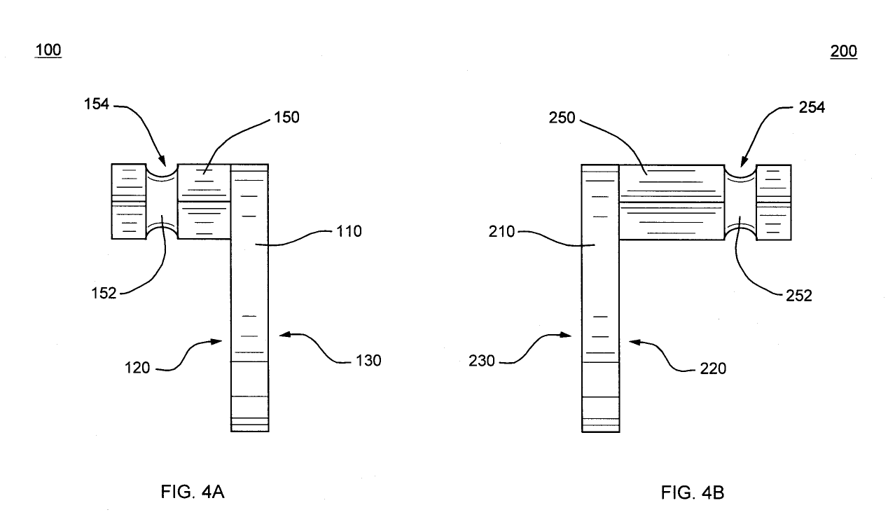

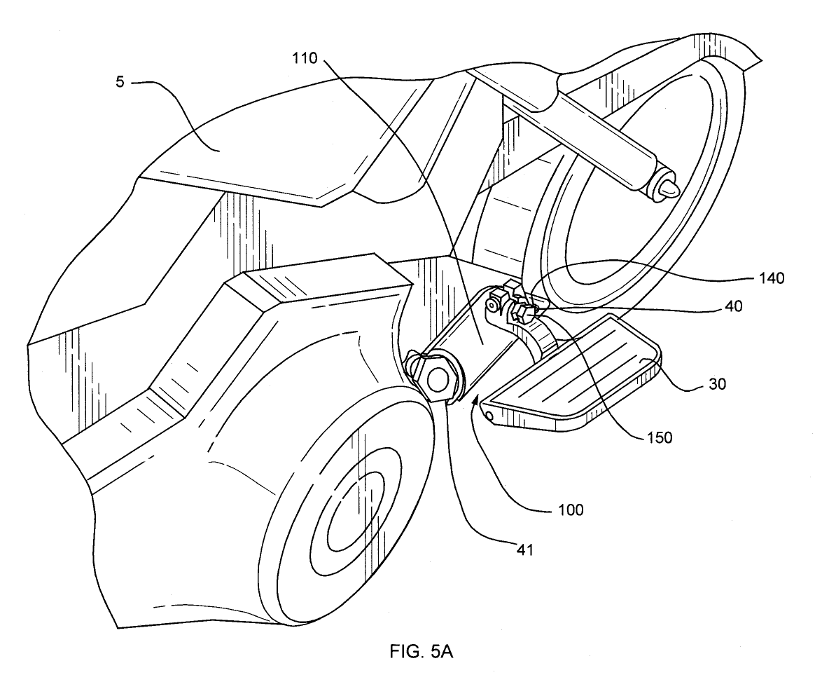

More specifically, the bracket of the present invention may be either a left-handed bracket, for removable connection to the left side of a motorcycle, or a right-handed bracket, for removable connection to the right side of a motorcycle. As shown in FIGS. 3A and 3B, each of the left-handed bracket 100 (FIG. 3A) and right-handed bracket 200 (FIG. 3B) includes a base member 110/210 having support connecting face 120/220 and a motorcycle mounting face 130/230 (shown in FIGS. 4A and 4B), which is on the side of the base member 110/210 from the opposite face 120/220. A recessed lip 112/212, which is recessed with respect to face 120/220, runs along arcuate recess 114/214 of the base member 110/210. At least one connecting port 140/240 extends entirely through the support connecting face 120/220 and the motorcycle mounting face. The connecting port 140/240 is encompassed by a recessed surface 141/241, which is recessed with respect to face 120/220.

Support connecting member 150/250 is removably connectable to, or integrally formed with, the base member 110/210 and extends beyond support connecting face 120/220. The support connecting member 150/250 may be of selectable length. Therefore, the support connecting member 150 may extend more or less beyond support connecting face 120 than does support connecting member 250, or the distances beyond the support connecting faces 120/220 that the support connecting members 150/250 extend may be equal. In a preferred embodiment of the present invention, which is shown in FIGS. 4A and 4B, the support connecting member 150/250 of the left-handed bracket 100 (FIG. 4A) and right-handed bracket 200 (FIG. 4B) is a hexagonal shank which includes a recessed groove 152/252 at or near midsection 154/254 of the member 150/250. The groove 152/252 runs along the entire perimeter of the connecting member 150/250. It is to be understood, however, that the connecting member 150/250 is not limited to being hexagonal, a shank or having a recessed groove. Those skilled in the art will recognize that other arrangements of the connecting member 150/250 are possible. Further, in this embodiment, the distance that the member 250 extends beyond support connecting face 220 of the right-handed bracket 200 is greater than is the distance that the member 150 extends beyond support connecting face 120 of the left-handed bracket 100. The greater extension of the member 250 of the right-handed bracket 200 allows the foot supporting device 30 to which it is connected to extend away from the exhaust pipes 10/20, which are on the right side of the motorcycle.

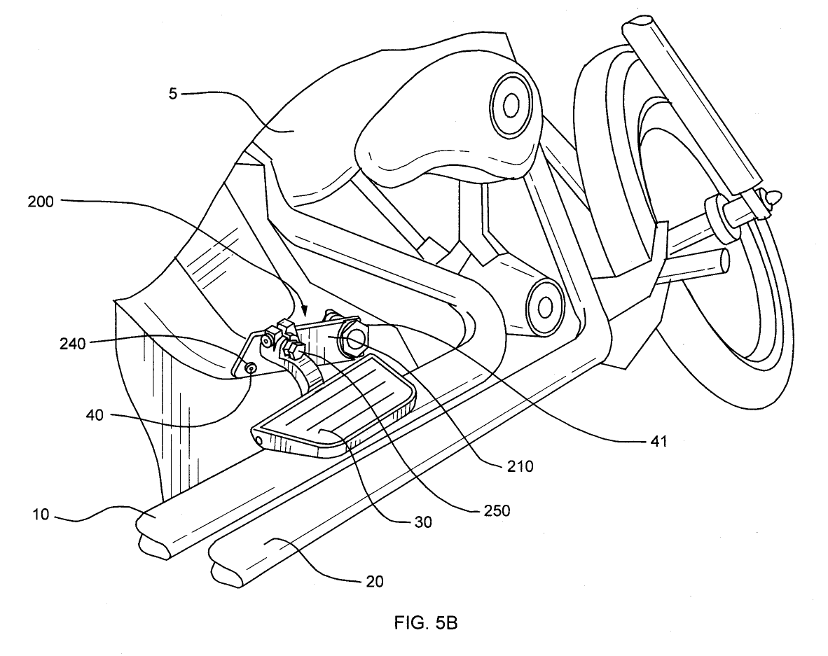

As shown in FIGS. 5A and 5B, the connecting member 150/250 may be used to removably connect the foot supporting device 30 to the bracket 100/200 while the bracket 100/200 is removably connected to the motorcycle. The foot supporting device 30 may be, for example, a footboard or a footpeg. Exemplary footboards include the following, all of which are commercially available from Harley: Streamliner Passenger Footboard (Harley Model No. 50420-05), Aileron Passenger Footboard (Harley Model No. 50429-04), and Swept Wing Passenger Footboard (Harley Model No. 50357-04). It is to be understood, however, that the foot supporting device 30 is not limited to these examples.

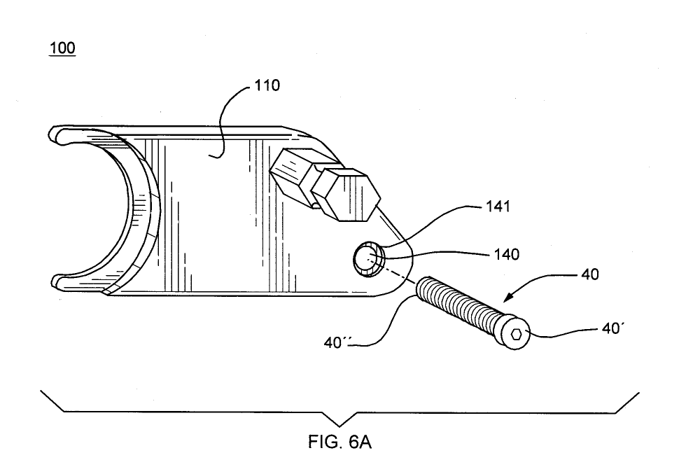

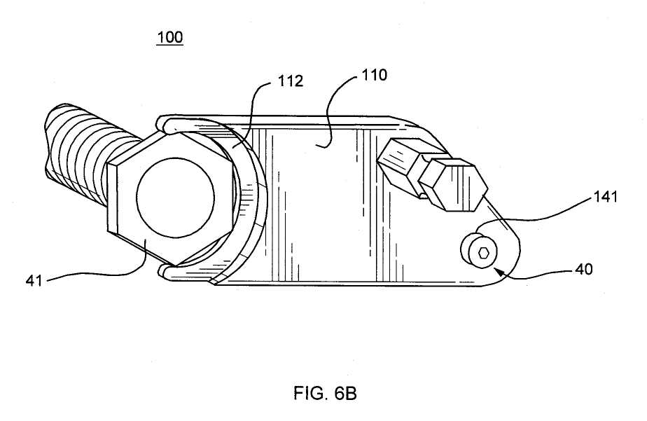

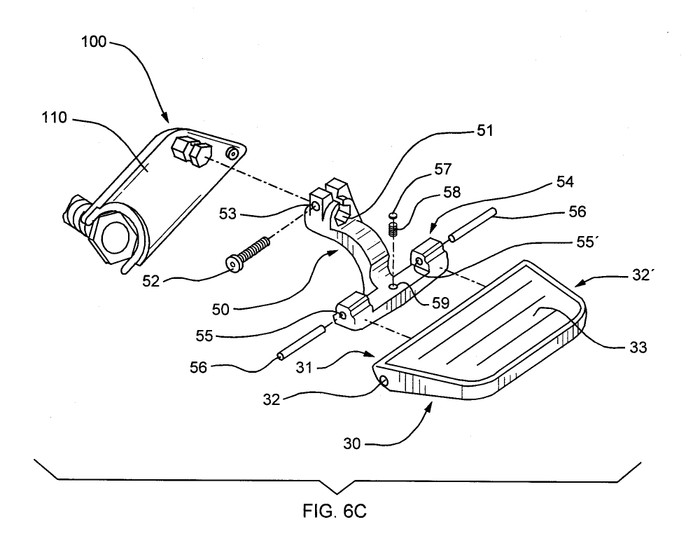

The bracket 100/200 may be removably connected to the motorcycle and the foot supporting device 30 may be removably connected to the bracket 100/200 generally as described with respect to FIGS. 6A-6C. (Although FIGS. 6A-6C show only these connections with respect to the left-handed bracket 100, it is to be understood that right-handed bracket 200 may be removably connected to the motorcycle and foot supporting device 30 in substantially the same manner.) Referring to FIG. 6A, a first connecting device 40, such as a socket head cap screw available from Harley (Harley Part Number 4310, for example), is placed through the connecting port 140 of the bracket 100 such that connecting device head 40′ contacts recessed face 141 of the port 140, but does not extend through the port 140, and connecting device end 40″ is securely and removably connected to the motorcycle. Similarly, as shown in FIG. 6B, a second connecting device 41, such as a threaded bolt, is removably connected to the motorcycle while contacting the recessed lip 112 of the bracket 100. In this arrangement, the second connecting device 41 helps removably secure the bracket 100 to the chassis 5 of the motorcycle by making secure contact with recess 114. Specifically, the recess 114 is sized to allow the head of the connecting device 41 to remain in substantially flush contact with the recess 114.

Referring to FIGS. 5A, 5B, and 6C, when the bracket 100 is removably connected to the motorcycle, a support arm 50, such as one available from Harley (Harley Part Number 52713-A, for example), is removably connected to the connecting member 150 of the bracket 100. This is achieved by placing first receiving port 51 of the support arm 50 around connecting member 150, and then removably securing the support arm 50 to the connecting member 150. The support arm 50 is removably secured to the connecting member 150 by inserting a third connecting device 52, such as a socket head screw cap available from Harley (Harley Part Number 3601, for example), into second receiving port 53 of the support arm 50.

With continuing reference to FIGS. 5A, 5B, and 6C, the foot supporting device 30 is removably connected to the support arm 50 by first inserting foot supporting device connecting end 54 of the support arm 50 into opening 31 of the foot supporting device 30 such that first end port 55 of connecting end 54 and first foot supporting device port 32 of the foot support device 30 are aligned with each other, and second end port 55′ of connecting end 54 and second foot supporting device port 32′ of the foot support device 30 are aligned with each other. The support arm 50 then may be removably connected to the foot supporting device 30 by removably inserting a fourth connecting device 56, such as a pivot pin available from Harley (Harley Part Number 50933-86, for example), through each of aligned ports 32 and 55 and aligned ports 32′ and 55′. In this arrangement, the foot supporting device 30 is partially pivotable. That is, foot resting surface 33 of the foot supporting device 30 may be pivoted about an axis of about 90 degrees. At one end of this axis, the foot supporting device 30 would be substantially parallel to face 110 of the bracket 100. At the other end of this axis, the foot supporting device 30 would be substantially perpendicular to face 110 of the bracket 100.

Optionally, a ball 57, such as Harley Part Number 8860, and spring 58, such as Harley Part Number 33085-74, may be included as part of the connection between the support arm 50 and foot supporting device 30. For example, the spring 58 may be compressably inserted into center port 59 of the connecting end 54 of the support arm 50, and while the spring 58 is compressed, the ball 57 may be rested on the spring 57. Further, while the ball 57 is being rested against the compressed spring 57, the connecting end 54 may be inserted into opening 31 and removably connected to the foot supporting device 30 as described above. When included, pressure exerted by ball 57 and spring 58 upon the foot supporting device 30 would substantially prevent the foot supporting device 30 from excessively vibrating against the support arm 50, such as might occur when the motorcycle is being ridden.

It is to be understood, however, that the connection of the bracket 100/200 to the motorcycle and foot supporting device 30 is not limited to the example described above. Those skilled in the art would recognize that other arrangements of the bracket 100/200 to the motorcycle and foot supporting device 30 are possible. It is also to be understood that the present invention includes a kit containing brackets 100 and 200 for placement of either or both on a Softail® motorcycle with a modified exhaust pipe system. The kit may optionally include instructions for affixing either or both brackets to the motorcycle.

While the present invention has been described with particular reference to certain embodiments of the bracket 100/200, it is to be understood that it includes all reasonable equivalents thereof as defined by the following appended claims.

What is claimed is:

1. A bracket for removably connecting a foot supporting device to a Softail® motorcycle having a chassis and a modified exhaust pipe system, the bracket comprising:
a. a base member having a first face and a second face;
b. a connecting port extending through the first face and the second face of the base member;
c. a foot support connecting member attached to the first face,
wherein the bracket is removably connectable to the motorcycle and the foot supporting device is removably connectable to the bracket, and wherein the foot supporting device, when connected to the bracket, extends beyond the lateral position of the modified exhaust pipe system.

2. The bracket of claim 1 wherein the bracket includes a recessed lip, which is recessed with respect to the first face of the bracket, and which runs along part or all of the perimeter of the bracket.

3. The bracket of claim 1 wherein the support connecting member is a hexagonal shank which is substantially at a right angle with respect to the first face.

4. The bracket of claim 3 wherein a recessed groove runs entirely around the perimeter of the shank.

5. The bracket of claim 1 wherein the foot supporting device is a footboard.

6. The bracket of claim 1 wherein the foot supporting device is removably connectable to the bracket via a support arm.

7. The bracket of claim 6 wherein the support arm includes a ball and spring.
